(19) United States
(12) Patent Application Publication
(10) Pub. No.: US 2025/0361344 A1
(43) Pub. Date: Nov. 27, 2025

(54) STYRENE BUTADIENE LATEX BINDER FOR WATERPROOFING APPLICATIONS

(71) Applicant: BASF SE, Ludwigshafen am Rhein (DE)

(72) Inventors: Kostas S. AVRAMIDIS, Charlotte, NC (US); Vanessa M. ADAMS, Fort Hill, NC (US); Jeremy J. FUNK, Charlotte, NC (US)

(21) Appl. No.: 19/289,746

(22) Filed: Aug. 4, 2025

Related U.S. Application Data
(62) Division of application No. 16/612,154, filed on Nov. 8, 2019.
(60) Provisional application No. 62/502,894, filed on May 8, 2017.

(51) Int. Cl. C08F 212/08; C08K 3/26; C08K 5/37; C09D 125/10

(52) U.S. Cl. CPC C08F 212/08; C09D 125/10; C08K 2003/265; C08K 5/37

(57) ABSTRACT

The present disclosure relates to compositions comprising a copolymer derived from polymerizing monomers comprising a vinyl aromatic monomer, butadiene, and an acid monomer, in the presence of a chain transfer agent. The chain transfer agent can be present in an amount sufficient to reduce the theoretical glass transition temperature (T_{g}) of the copolymer by at least 5° C. compared to a copolymer polymerized using identical monomers in the absence of the chain transfer agent. The compositions can be used to prepare compositions such as coatings that have improved water resistance. Methods of making the copolymers are also provided.

### FIELD OF THE DISCLOSURE

The present disclosure relates to compositions containing a copolymer derived from polymerizing styrene and butadiene in the presence of a chain transfer agent.

### BACKGROUND

A requirement of many building articles is that they be water resistant. This is because a high amount of water absorption can weaken these articles and lead to cracking. Waterborne coatings are commonly applied to a wide variety of substrates, such as wood, metal, masonry, plaster, stucco, and plastic. In many of these applications, the coating, which is based, upon an emulsion polymer, is exposed to wet environments caused by rain, dew, snow, and other sources of water. Waterborne coatings, especially clear aqueous coatings tend to blush or whiten when exposed to water. In particular, as a latex film forms, the particles initially coalesce at the air interface. Hydrophilic material is trapped in the interstices between particles. If the film composition is semipermeable, when it is exposed to water, the hydrophilic pockets will swell. The swollen pockets usually have a refractive index different from the polymer. As the pockets swell above a certain size, they scatter light, and the film becomes turbid. Various measures have been used to address this issue including crosslinking the polymer compositions.

There is a need for coatings and in particular, waterborne coatings having good water resistance and water blushing resistance. Such coatings would be of particular value for use as seam coatings or on structures such as concrete, tile, or brick surfaces. The compositions and methods described herein address these and other needs.

### SUMMARY OF THE DISCLOSURE

Provided herein are copolymers derived from polymerizing monomers comprising a vinyl aromatic monomer, a diene monomer, and an acid monomer in the presence of a chain transfer agent. The chain transfer agent can be present in an amount sufficient to reduce the theoretical glass transition temperature (T_{g}) of the copolymer by at least 5° C., compared to a copolymer polymerized using identical monomers in the absence of the chain transfer agent. In some embodiments, the chain transfer agent can be present in an amount to reduce the theoretical glass transition temperature (T_{g}) of the copolymer by from 5° C. to 20° C., compared to a copolymer polymerized using identical monomers in the absence of the chain transfer agent. For example, the chain transfer agent can be present in an amount to reduce the theoretical glass transition temperature (T_{g}) of the copolymer by 5° C. or greater, 10° C. or greater, 15° C. or greater, or 20° C. or greater, compared to a copolymer polymerized using identical monomers in the absence of the chain transfer agent.

Suitable chain transfer agents for use in polymerization of the copolymer can include n-octyl mercaptan, n-dodecyl mercaptan, t-octyl mercaptan, tetradecyl mercaptan, hexadecyl mercaptan, β-mercaptoethanol, 3-mercaptopropanol, tert-nonyl mercaptan, tert-dodecyl mercaptan, 6-mercaptomethyl-2-methyl-2-octanol, 4-mercapto-3-methyl-1-butanol, 2-phenyl-1-mercapto-2-ethanol, thioglycolic acid, methyl thioglycolate, n-butyl thioglycolate, i-octyl thioglycolate, dodecyl thioglycolate, octadecyl thioglycolate, methyl-3-mercaptopropionate, butyl-3-mercaptopropionate, i-octyl-3-mercaptopropionate, i-decyl-3-mercaptopropionate, dodecyl-3-mercaptopropionate, octadecyl-3-mercaptopropionate, or a mixture thereof. In some embodiments, the chain transfer agent includes a mercaptan such as tert-dodecyl mercaptan or tert-nonyl mercaptan. In some embodiments, the chain transfer agent can be in an amount of at least 1 part, at least 1.2 parts, at least 1.5 parts, at least 1.7 parts, at least 2 parts, at least 2.5 parts, at least 3 parts, at least 3.5 parts, or at least 4 parts per hundred monomers present in the copolymer. For example, the chain transfer agent can be present in an amount of from 1 part to 4 parts, from 1.5 part to 4 parts, from 1 part to 3.5 parts or from 1.5 part to 3 parts per hundred monomers present in the copolymer.

As described herein, the copolymer includes a vinyl aromatic monomer. The vinyl aromatic monomer can be present in an amount of at least 40% by weight of the copolymer. For example, the vinyl aromatic monomer can be present in an amount of from 40% to 80% or 50% to 70% by weight of the copolymer. An exemplary vinyl aromatic monomer for use in the copolymer includes styrene.

The copolymer also includes a diene monomer, such as butadiene. The diene monomer can be present in an amount of from 15% to 55% by weight of the copolymer. For example, the diene monomer can be present in an amount of from 20% to 50% or from 25% to 45% by weight of the copolymer.

In some embodiments, the copolymer can include an acid monomer. The acid monomer can be present in an amount of 4% or less by weight of the copolymer. For example, the acid monomer can be present in an amount of from 0.5% to 4% by weight of the copolymer. Suitable acid monomers for use in the copolymer can include acrylic acid, methacrylic acid, itaconic acid, maleic acid, fumaric acid, crotonic acid, or a mixture thereof.

The copolymer, in some cases, can include one or more additional monomers. The one or more additional monomers can include an organosilane. The organosilane may be copolymerized with the copolymer and/or present as a blend with the copolymer. When present, the organosilane can be represented by the formula (R¹)—(Si)—(OR²)₃, wherein R¹ is a C₁-C₈ substituted or unsubstituted alkyl or a C₁-C₈ substituted or unsubstituted alkene and R², which are the same or different, each is a C₁-C₈ substituted or unsubstituted alkyl group. Exemplary organosilanes can include vinyltrimethoxysilane, vinyltriethoxysilane, vinyl tris(2-methoxyethoxysilane), vinyl triisopropoxysilane, (meth)acryloyloxypropyltrimethoxysilane, γ-(meth)acryloxypropyltrimethoxysilane, γ-(meth)acryloxypropyltriethoxysilane, or a mixture thereof. The one or more additional monomers that may be present in the copolymer can include (meth)acrylate, (meth)acrylonitrile, (meth)acrylamide, 2-acrylamido-2-methyl propane sulfonic acid, a crosslinking monomer, a salt thereof, or a mixture thereof. In specific embodiments, the one or more additional monomers that may be present in the copolymer can include a socium salt of 2-acrylamido-2-methyl propane sulfonic acid. The one or more additional monomers can be present in an amount of 1% by weight or less, based on the total weight of the copolymer.

In certain embodiments, the copolymer can include 40% to 80% by weight styrene; 15% to 55% by weight of butadiene; 0.5% to 4% by weight of an acid monomer selected from itaconic acid, acrylic acid, or mixtures thereof; 0% to 4% by weight of an additional monomer selected from (meth)acrylate, (meth)acrylonitrile, (meth)acrylamide, 2-acrylamido-2-methyl propane sulfonic acid, acetoacetoxy monomer, vinyl acetate, organosilane, a salt thereof, or a mixture thereof; and 1 part to 4 parts by weight per hundred monomer of a chain transfer agent.

The copolymers described herein can have a theoretical glass-transition temperature of 40° C. or less. For example, the copolymer can have a theoretical glass-transition temperature of from −20° C. to 40° C., such as from −20° C. to 25° C.

The copolymer can have a gel content of 90% by weight or less such as 70% by weight or less. In some embodiments, the chain transfer agent can be present in an amount sufficient to reduce the gel content of the copolymer by 5% or greater (for example, 8% or greater, 10% or greater, 15% or greater, 20% or greater, or 25% or greater), compared to a copolymer polymerized using identical monomers in the absence of the chain transfer agent. In some embodiments, the copolymer has a number average particle size of 300 nm or less, such as from 100 nm to 250 nm of from 100 nm to 200 nm. In some embodiments, the copolymer is a single phase particle.

Compositions comprising the copolymers described herein are also disclosed. The copolymer can be present in an amount of 60% by weight or greater, based on the total amount of polymers in the composition. For example, the copolymer can be present in an amount of 80% by weight or greater, based on the total amount of polymers in the composition. In some embodiments, the composition includes an aqueous medium. The pH of the aqueous medium can be at least 8. In some cases, the aqueous medium is free or substantially free of ammonia.

The compositions comprising the copolymers disclosed herein can be a coating composition. In some embodiments, the coating composition can be a membrane. In some embodiments, the coating composition when dried, can exhibit a blush resistance of at least 24 hours when exposed to water. In some embodiments, the coating composition when dried, can exhibit a water absorption of less than 5% by weight, such as less than 10% by weight at 168 hours, according to a modified DIN 53-495 test. In some embodiments, the coating when dried, can exhibit a wet shear bond strength of at least 65 psi when used to bond a ceramic tile to a surface according to ANSI A 136.1 (2009). In some embodiments, the coating when dried, can exhibit a dry shear bond strength of at least 140 psi when used to bond a ceramic tile to a surface according to ANSI A 136.1 (2009). In some embodiments, the coating can exhibit a tensile strength of greater than 275 psi and an elongation at break of greater than 170% as set forth in ASTM D-2370 at 23° C.

In some embodiments, the coating compositions can be formulated as membranes for use in seam coatings. The membranes can include a copolymer as described herein, a filler comprising at least one pigment; a thickener; a defoamer; a dispersant; a surfactant; and water. The membrane can have a thickness of 2 mils or greater, such as 10 mils or greater, 20 mils or greater, or 30 mils or greater. When dried, the membrane can have a tensile strength of greater than 400 psi and an elongation at break of greater than 200% as set forth in ASTM D-2370 at 23° C. In some embodiments, the membrane when dried, can exhibit a blush resistance of at least 24 hours when exposed to water. In some embodiments, the membrane when dried, can exhibit a water absorption of less than 5% by weight, such as less than 10% by weight at 168 hours, according to a modified DIN 53-495 test. In some embodiments, the membrane can exhibit a wet peel strength of at least 6 lb_{f} according to a modified ASTM C794-93 test. In some embodiments, the membrane when dried, can exhibit a dry peel strength of at least 7 lb_{f} according to a modified ASTM C794-93 test. In some embodiments, the membrane when dried, can exhibit a water permeance of less than 0.1 perm, according to ASTM E-96 A. In some embodiments, the membrane when dried, can exhibit a water permeance of 0.2 perms or less, according to ASTM E-96 B.

Methods of making the copolymers are also disclosed herein. The method can include polymerizing monomers comprising a vinyl aromatic monomer, butadiene, and an acid monomer in the presence of a chain transfer agent; wherein the chain transfer agent is present in an amount sufficient to reduce the theoretical glass transition temperature (T_{g}) of the copolymer by at least 5° C., compared to a copolymer polymerized using identical monomers in the absence of the chain transfer agent. The monomers can be polymerized in the presence of a surfactant.

The details of one or more embodiments are set forth in the description below. Other features, objects, and advantages will be apparent from the description and from the claims.

### BRIEF DESCRIPTION OF THE DRAWINGS

The accompanying drawings, which are incorporated in and constitute a part of this specification, illustrate several embodiments of the disclosure and together with the description, serve to explain the principles of the disclosure.

FIGS. 1A-B are bar graphs showing the stress at peak (lb_{f}/in²) and percent elongation at break for formulated dry (FIG. 1A) and wet (FIG. 1B) membranes having a thickness of 30 mils.

FIG. 2 is a bar graph showing the stress at peak (lb_{f}/in²) and percent elongation at break for formulated dry membranes having a thickness of 20 mils or 25 mils.

FIG. 3 is a bar graph showing the stress at peak (lb_{f}/in²) and percent elongation at break for formulated wet membranes having a thickness of 20 mils or 25 mils.

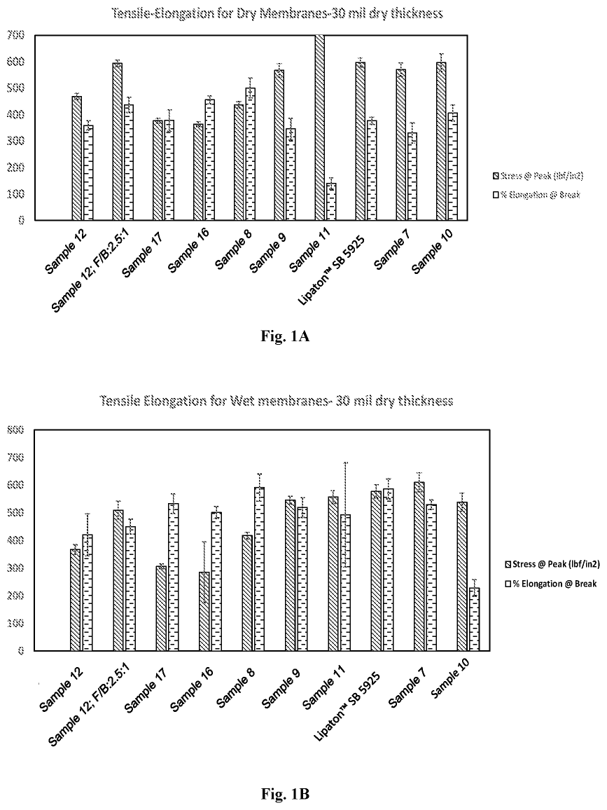

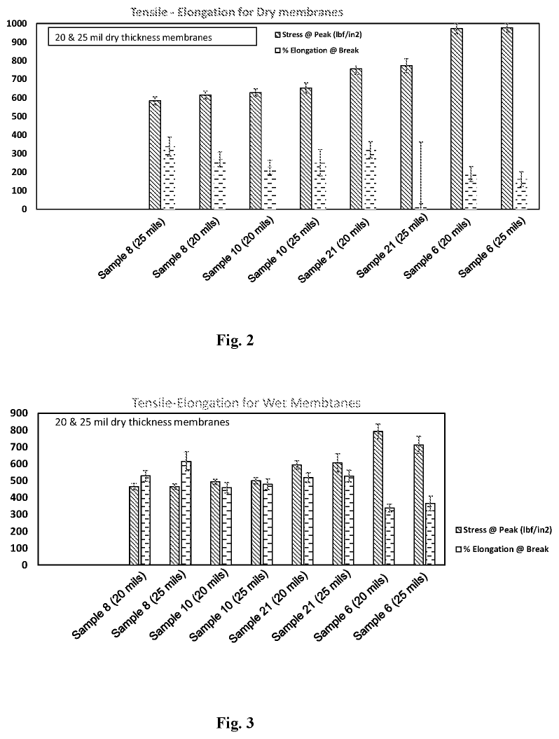

### DETAILED DESCRIPTION

Provided herein are copolymers, compositions thereof, and methods of making and using the copolymer and copolymer compositions. The copolymers disclosed herein can be derived from monomers comprising a vinyl aromatic monomer, a diene monomer, and an acid monomer. The monomers are polymerized in the presence of a chain transfer agent.

Suitable vinyl aromatic monomers for use in the copolymers can include styrene or an alkyl styrene such as α- and p-methylstyrene, α-butylstyrene, p-n-butylstyrene, p-n-decylstyrene, vinyltoluene, and combinations thereof. The vinyl aromatic monomer can be present in an amount of 40% by weight or greater (e.g., 42% by weight or greater, 45% by weight or greater, 50% by weight or greater, 55% by weight or greater, 60% by weight or greater, 65% by weight or greater, or 70% by weight or greater), based on the total weight of monomers from which the copolymer is derived. In some embodiments, vinyl aromatic monomer can be present in the copolymer in an amount of 85% by weight or less (e.g., 80% by weight or less, 75% by weight or less, 70% by weight or less, 65% by weight or less, 60% by weight or less, 55% by weight or less, or 50% by weight or less) based on the total weight of monomers from which the copolymer is derived. The copolymer can be derived from any of the minimum values to any of the maximum values by weight described above of the vinyl aromatic monomer. For example, the copolymer can be derived from 40% to 85% by weight (e.g., from 40% to 80%, from 40% to 75%, from 45% to 80%, from 45% to 75%, from 45% to 70%, from 50% to 80%, from 50% to 75%, or from 55% to 80% by weight of vinyl aromatic monomer), based on the total weight of monomers from which the copolymer is derived.

As disclosed herein, the copolymer includes a diene monomer. The diene monomer can include 1,2-butadiene (i.e. butadiene); conjugated dienes (e.g. 1,3-butadiene, 2-methyl-1,3-butadiene, 2-chloro-1,3-butadiene, and isoprene), or mixtures thereof. In some embodiments, the copolymer includes butadiene. The diene monomer can be present in an amount of 15% by weight or greater (e.g., 20% by weight or greater, 25% by weight or greater, 30% by weight or greater, 35% by weight or greater, 40% by weight or greater, 45% by weight or greater, 50% by weight or greater, or 55% by weight or greater), based on the total weight of monomers from which the copolymer is derived. In some embodiments, diene monomer can be present in the copolymer in an amount of 58% by weight or less (e.g., 55% by weight or less, 50% by weight or less, 45% by weight or less, 40% by weight or less, 35% by weight or less, 30% by weight or less, 25% by weight or less, or 20% by weight or less) based on the total weight of monomers from which the copolymer is derived. The copolymer can be derived from any of the minimum values to any of the maximum values by weight described above of the diene monomer. For example, the copolymer can be derived from 15% to 58% by weight (e.g., from 15% 55%, from 15% to 50%, from 15% to 45%, from 15% to 40%, from 20% to 58%, from 20% to 55%, from 20% to 50%, or from 25% to 50% by weight of diene monomer), based on the total weight of monomers from which the copolymer is derived.

The copolymers disclosed herein can be further derived from an acid monomer. The acid monomer can include a carboxylic acid-containing monomer. Examples of carboxylic acid-containing monomers include α,β-monoethylenically unsaturated mono- and dicarboxylic acids. In some embodiments, the one or more carboxylic acid-containing monomers can be selected from the group consisting of acrylic acid, methacrylic acid, itaconic acid, maleic acid, fumaric acid, crotonic acid, dimethacrylic acid, ethylacrylic acid, allylacetic acid, vinylacetic acid, mesaconic acid, methylenemalonic acid, styrene carboxylic acid, citraconic acid, and combinations thereof.

The copolymer can be derived from 4% or less (e.g., 3.5% or less, 3% or less, 2.5% or less, 2% or less, 1.5% or less, or 1% or less) by weight of acid-containing monomers, based on the total weight of monomers from which the copolymer is derived. In some embodiments, the copolymer can be derived from greater than 0% (e.g., 0.1% or greater, 0.3% or greater, 0.5% or greater, or 1% or greater) by weight of acid-containing monomers, based on the total weight of monomers from which the copolymer is derived. In certain embodiments, the copolymer can be derived from 0.1% to 4% by weight, from 0.5% by weight to 4% by weight or from 0.5% by weight to 3.5% by weight of one or more acid-containing monomers, based on the total weight of monomers from which the copolymer is derived.

In addition to being derived from a vinyl aromatic monomer, a diene monomer, and an acid monomer, the copolymers disclosed herein may be further derived from one or more additional monomers. The one or more additional monomers can include a (meth)acrylate monomer. As used herein, “(meth)acryl . . . ” includes acryl . . . , methacryl . . . , diacryl . . . , and dimethacryl . . . . For example, the term “(meth)acrylate monomer” includes acrylate, methacrylate, diacrylate, and dimethacrylate monomers. The (meth)acrylate monomer can include esters of α,β-monoethylenically unsaturated monocarboxylic and dicarboxylic acids having 3 to 6 carbon atoms with alkanols having 1 to 20 carbon atoms (e.g., esters of acrylic acid, methacrylic acid, maleic acid, fumaric acid, or itaconic acid, with C₁-C₂₀, C₄-C₂₀, C₁-C₁₆, or C₄-C₁₆ alkanols).

Exemplary (meth)acrylate monomers that can be used in the copolymers include ethyl (meth)acrylate, n-butyl (meth)acrylate, iso-butyl (meth)acrylate, tert-butyl (meth)acrylate, isobutyl (meth)acrylate, n-hexyl (meth)acrylate, 2-ethylhexyl (meth)acrylate, n-heptyl (meth)acrylate, 2-methyheptyl(meth)acrylate, octyl (meth)acrylate, isooctyl (meth)acrylate, n-nonyl (meth)acrylate, isononyl (meth)acrylate, n-decyl (meth)acrylate, isodecyl (meth)acrylate, dodecyl (meth)acrylate, heptadecyl (meth)acrylate, lauryl (meth)acrylate, tridecyl (meth)acrylate, stearyl (meth)acrylate, glycidyl (meth)acrylate, allyl (meth)acrylate, tetrahydrofurfuryl (meth)acrylate, cyclohexyl (meth)acrylate, 2-propylheptyl (meth)acrylate, behenyl (meth)acrylate, cyclohexyl methacrylate, t-butyl acrylate, t-butyl methacrylate, stearyl methacrylate, behenyl methacrylate, allyl methacrylate, or combinations thereof. The copolymers can be derived from 0% by weight to 15% by weight or less of one or more (meth)acrylate monomers (e.g., 10% by weight or less, 8% by weight or less, 7% by weight or less, 6% by weight or 5% by weight or less, 4% by weight or less, 3% by weight or less, 2% by weight or less, 1% by weight or less, or 0% by weight of the (meth)acrylate monomer) based on the total weight of monomers from which the copolymer is derived.

The one or more additional monomers can include a silane-containing monomer. The silane-containing monomer can include an organosilane defined by the general Formula IV below:

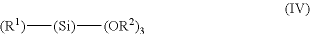

wherein R¹ is a C₁-C₈ substituted or unsubstituted alkyl or a C₁-C₈ substituted or unsubstituted alkene and each of R² is independently a C₁-C₈ substituted or unsubstituted alkyl group. Suitable silane containing monomers can include, for example, vinyl silanes such as vinyltrimethoxysilane, vinyltriethoxysilane (VTEO), vinyl tris(2-methoxyethoxysilane), and vinyl triisopropoxysilane, and (meth)acrylatoalkoxysilanes, such as (meth)acryloyloxypropyltrimethoxysilane, γ-(meth)acryloxypropyltrimethoxysilane, γ-(meth)acryloxypropyltriethoxysilane, or a combination thereof.

In some embodiments, the silane-containing monomer can be copolymerized with the copolymer. For example, the silane-containing monomer can act as crosslinkers in the copolymers. In some embodiments, the silane-containing monomer can be present as a blend with the copolymers. For example, the silane-containing monomer can be present in a composition comprising the copolymer rather than copolymerized with other monomers in the copolymer. In some examples, the silane-containing monomer can be copolymerized in the copolymer as well as present as a blend with the copolymer.

In some embodiments, the silane containing monomer can include a multivinyl siloxane oligomer. Multivinyl siloxane oligomers are described in U.S. Pat. No. 8,906,997, which is hereby incorporated by reference in its entirety. The multivinyl siloxane oligomer can include oligomers having a Si—O—Si backbone. For example, the multivinyl siloxane oligomer can have a structure represented by the Formula V below:

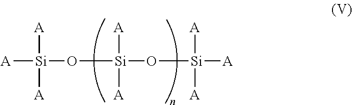

wherein each of the A groups are independently selected from hydrogen, hydroxy, alkoxy, substituted or unsubstituted C₁₋₄ alkyl, or substituted or unsubstituted C₂₋₄ alkenyl and n is an integer from 1 to 50 (e.g., 10). As used herein, the terms “alkyl” and “alkenyl” include straight- and branched-chain monovalent substituents. Examples include methyl, ethyl, propyl, butyl, isobutyl, vinyl, allyl, and the like. The term “alkoxy” includes alkyl groups attached to the molecule through an oxygen atom. Examples include methoxy, ethoxy, and isopropoxy.

In some embodiments, at least one of the A groups in the repeating portion of Formula V are vinyl groups. The presence of multiple vinyl groups in the multivinyl siloxane oligomers enables the oligomer molecules to act as crosslinkers in compositions comprising the copolymers. In some examples, the multivinyl siloxane oligomer can have the following structure represented by Formula Va below:

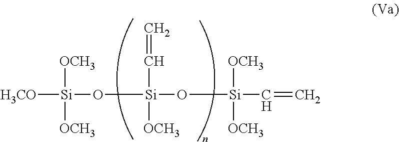

In Formula Va, n is an integer from 1 to 50 (e.g., 10). Further examples of suitable multivinyl siloxane oligomers include DYNASYLAN 6490, a multivinyl siloxane oligomer derived from vinyltrimethoxysilane, and DYNASYLAN 6498, a multivinyl siloxane oligomer derived from vinyltriethoxysilane, both commercially available from Evonik Degussa GmbH (Essen, Germany). Other suitable multivinyl siloxane oligomers include VMM-010, a vinylmethoxysiloxane homopolymer, and VEE-005, a vinylethoxysiloxane homopolymer, both commercially available from Gelest, Inc. (Morrisville, PA).

When present, the copolymer can include from greater than 0% by weight to 5% by weight of the silane-containing monomer, based on the total weight of monomers from which the copolymer is derived. In certain embodiments, the copolymer can be derived from greater than 0% by weight to 2.5% by weight of the silane-containing monomer, based on the total weight of monomers from which the copolymer is derived. In some embodiments, the copolymer is derived from 5% or less, 4% or less, 3.5% or less, 3% or less, 2.5% or less, 2% or less, or 1% or less by weight of the silane-containing monomer, based on the total weight of monomers from which the copolymer is derived. In some embodiments, the copolymer is derived from 0.1% or greater, 0.3% or greater, 0.5% or greater, 0.75% or greater, or 1% or greater by weight of the silane-containing monomer, based on the total weight of monomers from which the copolymer is derived.

In some embodiments, the copolymer includes a (meth)acrylamide or a derivative thereof. The (meth)acrylamide derivative include, for example, keto-containing amide functional monomers defined by the general Formula VI below

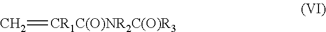

wherein R₁ is hydrogen or methyl; R₂ is hydrogen, a C₁-C₄ alkyl group, or a phenyl group; and R₃ is hydrogen, a C₁-C₄ alkyl group, or a phenyl group. For example, the (meth)acrylamide derivative can be diacetone acrylamide (DAAM) or diacetone methacrylamide. Suitable acetoacetoxy monomers that can be included in the copolymer include acetoacetoxyalkyl (meth)acrylates, such as acetoacetoxyethyl (meth)acrylate (AAEM), acetoacetoxypropyl (meth)acrylate, acetoacetoxybutyl (meth)acrylate, and 2,3-di(acetoacetoxy)propyl (meth)acrylate; allyl acetoacetate; vinyl acetoacetate; and combinations thereof. Sulfur-containing monomers that can be included in the copolymer include, for example, sulfonic acids and sulfonates, such as vinylsulfonic acid, 2-sulfoethyl methacrylate, sodium styrenesulfonate, 2-sulfoxyethyl methacrylate, vinyl butylsulfonate, sulfones such as vinylsulfone, sulfoxides such as vinylsulfoxide, and sulfides such as 1-(2-hydroxyethylthio) butadiene. Examples of suitable phosphorus-containing monomers that can be included in the copolymer include dihydrogen phosphate esters of alcohols in which the alcohol contains a polymerizable vinyl or olefenic group, allyl phosphate, phosphoalkyl(meth)acrylates such as 2-phosphoethyl(meth)acrylate (PEM), 2-phosphopropyl(meth)acrylate, 3-phosphopropyl (meth)acrylate, and phosphobutyl(meth)acrylate, 3-phospho-2-hydroxypropyl(meth)acrylate, mono- or di-phosphates of bis(hydroxymethyl) fumarate or itaconate; phosphates of hydroxyalkyl(meth)acrylate, 2-hydroxyethyl(meth)acrylate, 3-hydroxypropyl(meth)acrylate, ethylene oxide condensates of (meth)acrylates, H₂C═C(CH₃)COO(CH₂CH₂O)ₙP(O)(OH)₂, and analogous propylene and butylene oxide condensates, where n is an amount of 1 to 50, phosphoalkyl crotonates, phosphoalkyl maleates, phosphoalkyl fumarates, phosphodialkyl (meth)acrylates, phosphodialkyl crotonates, vinyl phosphonic acid, allyl phosphonic acid, 2-acrylamido-2-methylpropanephosphinic acid, 2-acrylamido-2-methyl propane sulfonic acid or a salt thereof (such as sodium, ammonium, or potassium salts), α-phosphonostyrene, 2-methylacrylamido-2-methylpropanephosphinic acid, (hydroxy)phosphinylalkyl(meth)acrylates, (hydroxy)phosphinylmethyl methacrylate, and combinations thereof. In some embodiments, the copolymer includes 2-acrylamido-2-methyl propane sulfonic acid. Hydroxy (meth)acrylates that can be included in the copolymer include, for example, hydroxyl functional monomers defined by the general Formula VII below

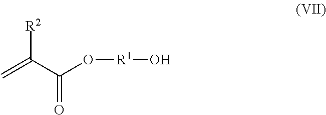

wherein R¹ is hydrogen or methyl and R₂ is hydrogen, a C₁-C₄ alkyl group, or a phenyl group. For example, the hydroxyl (meth)acrylate can include hydroxypropyl (meth)acrylate, hydroxybutylacrylate, hydroxybutylmethacrylate, hydroxyethylacrylate (HEA) and hydroxyethylmethacrylate (HEMA).

Other suitable additional monomers that can be included in the copolymer include (meth)acrylonitrile, vinyl halide, vinyl ether of an alcohol comprising 1 to 10 carbon atoms, aliphatic hydrocarbon having 2 to 8 carbon atoms and one or two double bonds, phosphorus-containing monomer, acetoacetoxy monomer, sulfur-based monomer, hydroxyl (meth)acrylate monomer, methyl (meth)acrylate, ethyl (meth)acrylate, alkyl crotonates, di-n-butyl maleate, di-octylmaleate, acetoacetoxyethyl (meth)acrylate, acetoacetoxypropyl (meth)acrylate, allyl (meth)acrylate, tetrahydrofurfuryl (meth)acrylate, cyclohexyl (meth)acrylate, 2-ethoxyethyl (meth)acrylate, 2-methoxy (meth)acrylate, 2-(2ethoxyethoxy)ethyl (meth)acrylate, 2-phenoxyethyl (meth)acrylate, isobornyl (meth)acrylate, caprolactone (meth)acrylate, polypropyleneglycol mono(meth)acrylate, polyethyleneglycol (meth)acrylate, benzyl (meth)acrylate, 2,3-di(acetoacetoxy)propyl (meth)acrylate, methylpolyglycol (meth)acrylate, 3,4-epoxycyclohexylmethyl (meth)acrylate, 1,6 hexanediol di(meth)acrylate, 1,4 butanediol di(meth)acrylate, or combinations thereof.

When present, the one or more additional monomers can be present in small amounts (e.g., 10% by weight or less, 7.5% by weight or less, 5% by weight or less, 4% by weight or less, 3% by weight or less, 2% by weight or less, 1.5% by weight or less, 1% by weight or less, or 0.5% by weight or less), based on the total weight of monomers from which the copolymer is derived. The one or more additional monomers when present can be present in an amount of greater than 0%, 0.1% by weight or greater, 0.3% or greater, 0.5% or greater, 0.75% or greater, or 1% or greater by weight, based on the total weight of monomers from which the copolymer is derived.

As described herein, the monomers in the copolymer are polymerized in the presence of a chain transfer agent. A “chain transfer agent” as used herein refers to chemical compounds that are useful for controlling the molecular weights of polymers, for reducing gelation when polymerizations and copolymerizations involving diene monomers are conducted, and/or for preparing polymers and copolymers with useful chemical functionality at their chain ends. The chain transfer agent reacts with a growing polymer radical, causing the growing chain to terminate while creating a new reactive species capable of initiating polymerization. The phrase “chain transfer agent” is used interchangeably with the phrase “molecular weight regulator.”

Suitable chain transfer agents for use during polymerization of the copolymers disclosed herein can include compounds having a carbon-halogen bond, a sulfur-hydrogen bond, a silicon-hydrogen bond, or a sulfur-sulfur bond; an allyl alcohol, or an aldehyde. In some embodiments, the chain transfer agents contain a sulfur-hydrogen bond, and are known as mercaptans. In some embodiments, the chain transfer agent can include C₃-C₂₀ mercaptans. Specific examples of the chain transfer agent can include octyl mercaptan such as n-octyl mercaptan and t-octyl mercaptan, decyl mercaptan, tetradecyl mercaptan, hexadecyl mercaptan, dodecyl mercaptan such as n-dodecyl mercaptan and t-dodecyl mercaptan, tert-butyl mercaptan, mercaptoethanol such as β-mercaptoethanol, 3-mercaptopropanol, mercaptopropyltrimethoxysilane, tert-nonyl mercaptan, tert-dodecyl mercaptan, 6-mercaptomethyl-2-methyl-2-octanol, 4-mercapto-3-methyl-1-butanol, methyl-3-mercaptopropionate, butyl-3-mercaptopropionate, i-octyl-3-mercaptopropionate, i-decyl-3-mercaptopropionate, dodecyl-3-mercaptopropionate, octadecyl-3-mercaptopropionate, and 2-phenyl-1-mercapto-2-ethanol. Other suitable examples of chain transfer agents that can be used during polymerization of the copolymers include thioglycolic acid, methyl thioglycolate, n-butyl thioglycolate, i-octyl thioglycolate, dodecyl thioglycolate, octadecyl thioglycolate, ethylacrylic esters, terpinolene. In some examples, the chain transfer agent can include tert-dodecyl mercaptan.

Without wishing to be bound by theory, the glass transition temperature of the copolymers disclosed herein can be influenced by the presence of the chain transfer agent during polymerization. In particular, the Flory-Fox equation relates the number-average molecular weight, Mn, to the glass transition temperature, Tg, of a polymer as shown below:

$${T}_{g} = {T}_{g , ∞} - K / {M}_{n}$$

where Tg,∞ is the maximum glass transition temperature that can be achieved at a theoretical infinite molecular weight and K is an empirical parameter that is related to the free volume present in the polymer sample.

Free volume decreases upon cooling from the rubbery state until the glass transition temperature at which point the molecular rearrangement is effectively “frozen” out, so the polymer chains lack sufficient free volume to achieve different physical conformations. This ability to achieve different physical conformations is called segmental mobility. Free volume not only depends on temperature, but also on the number of polymer chain ends present in the system. End chain units exhibit greater free volume than units within the chain because the covalent bonds that make up the polymer are shorter than the intermolecular nearest neighbor distances found at the end of the chain. In other words, end chain units are less dense than the covalently bonded interchain units. This means that a polymer sample with long chain lengths (high molecular weights) will have fewer chain ends per total units and less free volume than a polymer sample consisting of short chains. In short, when considering the packing of chains, more chain ends result in a lower Tg.

Thus, glass transition temperature is dependent on free volume, which in turn is dependent on the average molecular weight of the polymer sample. This relationship is described by the Flory-Fox equation. Low molecular weight values result in lower glass transition temperatures and increasing values of molecular weight result in an increase in the glass transition temperature.

The amount of chain transfer agent utilized during polymerization can be in an effective amount to reduce the glass transition temperature (Tg) of the copolymer, compared to a copolymer polymerized using identical monomers in the absence of a chain transfer agent. That is, polymerization of the monomers in the absence of the chain transfer agent tend to increase the glass transition temperature of the resulting copolymer. In some embodiments, the chain transfer agent can be in an effective amount to reduce the glass transition temperature of the copolymer by at least 5° C., compared to a copolymer polymerized using identical monomers in the absence of a chain transfer agent. For example, the chain transfer agent can be in an effective amount to reduce the glass transition temperature of the copolymer by 5° C. or greater, 6° C. or greater, 7° C. or greater, 8° C. or greater, 9° C. or greater, 10° C. or greater, 11° C. or greater, 12° C. or greater, 13° C. or greater, 14° C. or greater, 15° C. or greater, 16° C. or greater, 17° C. or greater, 18° C. or greater, 19° C. or greater, or 20° C. or greater, compared to a copolymer polymerized using identical monomers in the absence of a chain transfer agent. In some embodiments, the chain transfer agent can be in an effective amount to reduce the glass transition temperature of the copolymer by from 5° C. to 20° C., from 5° C. to 18° C., from 7° C. to 20° C., from 7° C. to 18° C., from 9° C. to 20° C., or from 9° C. to 18° C., compared to a copolymer polymerized using identical monomers in the absence of a chain transfer agent.

The amount of chain transfer agent used in the polymerization reaction can be present in an amount of at least 1 part per hundred monomers present in the copolymer. For example, the chain transfer agent can be present in an amount of 1.2 parts or greater, 1.5 parts or greater, 2 parts or greater, or 2.5 parts or greater per hundred monomers present in the copolymer during polymerization. In some embodiments, the chain transfer agent can be present in an amount of 4 parts or less, 3.5 parts or less, 3 parts or less, or 2.5 parts or less per hundred monomers present in the copolymer during polymerization. In some embodiments, the chain transfer agent can be present in an amount from 1 part to 4 parts, from 1.5 parts to 4 parts, from 1 part to 3.5 parts, from 1.5 parts to 3.5 parts, from 1 part to 3 parts, from 1.5 parts to 3 parts, or from 1 part to 2.5 parts per hundred monomers present in the copolymer during polymerization.

When the chain transfer agent is used, the resulting copolymer can contain from about 0.01% to about 4%, from about 0.05% to about 4%, from about 0.1% to about 4%, or from about 0.1% to about 3.5% by weight of the chain transfer agent.

The copolymers described herein can have a theoretical glass-transition temperature (Tg) and/or a Tg as measured by differential scanning calorimetry (DSC) using the mid-point temperature using the method described, for example, in ASTM 3418/82, of 40° C. or less (e.g., 35° C. or less, 30° C. or less, 25° C. or less, 20° C. or less, 15° C. or less, 12° C. or less, 10° C. or less, 8° C. or less, 5° C. or less, 3° C. or less, 1° C. or less, 0° C. or less, −3° C. or less, −5° C. or less, or −8° C. or less). The copolymers can have a theoretical Tg and/or a Tg as measured by DSC using the mid-point temperature using the method described, for example, in ASTM 3418/82, of −40° C. or greater (e.g., −35° C. or greater, −30° C. or greater, −25° C. or greater, −20° C. or greater, −15° C. or greater, −10° C. or greater, −5° C. or greater, 0° C. or greater, 5° C. or greater, 10° C. or greater, 15° C. or greater, 20° C. or greater, 25° C. or greater, or 30° C. or greater). The copolymers can have a theoretical Tg and/or a Tg as measured by DSC using the mid-point temperature using the method described, for example, in ASTM 3418/82, ranging from any of the minimum values described above to any of the maximum values described above. For example, the copolymers can have a theoretical glass-transition temperature (Tg) and/or a Tg as measured by differential scanning calorimetry (DSC) using the mid-point temperature using the method described, for example, in ASTM 3418/82, of from −40° C. to 40° C. (e.g., from −20° C. to 40° C., from −20° C. to 25° C., from −20° C. to 20° C., from −20° C. to 15° C., from −20° C. to 10° C., from −20° C. to 5° C., from −15° C. to 25° C., from −15° C. to 20° C., from −15° C. to 15° C., from −15° C. to 10° C., from −10° C. to 25° C., from −10° C. to 20° C., or from −10° C. to 15° C.).

In some embodiments, copolymers polymerized in the absence of a chain transfer agent, but using identical monomers as the inventive copolymers disclosed herein, can have a theoretical glass-transition temperature (Tg) and/or a Tg as measured by differential scanning calorimetry (DSC) using the mid-point temperature using the method described, for example, in ASTM 3418/82, of 60° C. or less (e.g., 55° C. or less, 50° C. or less, 45° C. or less, 40° C. or less, 35° C. or less, 30° C. or less, or 25° C. or less). In some embodiments, copolymers polymerized in the absence of a chain transfer agent, but using identical monomers as the inventive copolymers disclosed herein, can have a theoretical glass-transition temperature (Tg) and/or a Tg as measured by differential scanning calorimetry (DSC) using the mid-point temperature using the method described, for example, in ASTM 3418/82, of 10° C. or greater (e.g., 15° C. or greater, 20° C. or greater, 25° C. or greater, 30° C. or greater, 35° C. or greater, 40° C. or greater45° C. or greater, 50° C. or greater, or 55° C. or greater). In some embodiments, copolymers polymerized in the absence of a chain transfer agent, but using identical monomers as the inventive copolymers disclosed herein, can have a theoretical glass-transition temperature (Tg) and/or a Tg as measured by differential scanning calorimetry (DSC) using the mid-point temperature using the method described, for example, in ASTM 3418/82, of from 10° C. to 60° C. (e.g., from 10° C. to 40° C., from 15° C. to 40° C., from 20° C. to 40° C., or from 15° C. to 35° C.).

The theoretical glass transition temperature or “theoretical T_{g}” of the copolymer refers to the estimated T_{g} calculated using the Fox equation. The Fox equation can be used to estimate the glass transition temperature of a polymer or copolymer as described, for example, in L. H. Sperling, “Introduction to Physical Polymer Science”, 2^{nd} Edition, John Wiley & Sons, New York, p. 357 (1992) and T. G. Fox, Bull. Am. Phys. Soc, 1, 123 (1956), both of which are incorporated herein by reference. For example, the theoretical glass transition temperature of a copolymer derived from monomers a, b, . . . , and i can be calculated according to the equation below

$$\frac{1}{{{T}_{g}}_{}} = \frac{{w}_{a}}{{T}_{g a}} + \frac{{w}_{b}}{{T}_{g b}} + … + \frac{{w}_{i}}{{T}_{g i}}$$

where wₐ is the weight fraction of monomer a in the copolymer, T_{ga} is the glass transition temperature of a homopolymer of monomer a, w_{b} is the weight fraction of monomer b in the copolymer, T_{gb} is the glass transition temperature of a homopolymer of monomer b, wᵢ is the weight fraction of monomer i in the copolymer, T_{gi} is the glass transition temperature of a homopolymer of monomer i, and T_{g} is the theoretical glass transition temperature of the copolymer derived from monomers a, b, . . . , and i.

The copolymers can comprise particles having a small particle size. In some embodiments, the copolymers can comprise particles having a number average particle size of 300 nm or less (e.g., 280 nm or less, 270 nm or less, 250 nm or less, 230 nm or less, 210 nm or less, 200 nm or less, 180 nm or less, 160 nm or less, 150 nm or less, 140 nm or less, 130 nm or less, 120 nm or less, 110 nm or less, 100 nm or less, 95 nm or less, 90 nm or less, or 85 nm or less). In some embodiments, the copolymers can have a number average particle size of 10 nm or greater, 20 nm or greater, 30 nm or greater, 35 nm or greater, 40 nm or greater, 45 nm or greater, 50 nm or greater, 55 nm or greater, 60 nm or greater, 65 nm or greater, 80 nm or greater, 100 nm or greater, 120 nm or greater, 130 nm or greater, 140 nm or greater, 150 nm or greater, 160 nm or greater, 180 nm or greater, 200 nm or greater, 220 nm or greater, 250 nm or greater, or 280 nm or greater,. In some embodiments, the copolymers can have a number average particle size of from 10 nm to 300 nm, from 10 nm to 250 nm, from 10 nm to 220 nm, 10 nm to 200 nm, from 10 nm to 180 nm, from 10 nm to 150 nm, from 10 nm to 130 nm, from 10 nm 120 nm, 10 nm to 100 nm, from 10 nm to less than 100 nm, from 20 nm to 300 nm, from 20 nm to 250 nm, from 30 nm to 250 nm, from 40 nm to 250 nm, from 40 nm to 200 nm, or from 40 nm to 150 nm. In some embodiments, the copolymers can have a volume average particle size of from 10 nm to 300 nm, from 10 nm to 250 nm, 10 nm to 220 nm, 10 nm to 200 nm, from 10 nm to 180 nm, from 10 nm to 150 nm, from 10 nm to 130 nm, from 10 nm 120 nm, 10 nm to 100 nm, or from 10 nm to less than 100 nm. The ratio between the volume average particle size (in nm) and the number average particle size (in nm) can be from 1.0 to 1.2 or from 1.0 to 1.1. The particle size can be determined using dynamic light scattering measurements using the Nanotrac Wave II Q available from Microtrac Inc., Montgomeryville, PA.

In some embodiments, the weight average molecular weight of the copolymers can be greater than 1,000,000 Da. As described herein, the molecular weight of the copolymers can be adjusted by the amount of chain transfer agent added during polymerization, such that the weight average molecular weight of the copolymers is less than 1,000,000 Da. In some embodiments, the weight average molecular weight of the copolymers can be 10,000 Da or greater (e.g., 20,000 Da or greater, 50,000 Da or greater, 75,000 Da or greater, 100,000 Da or greater, 150,000 Da or greater, 200,000 Da or greater, 300,000 Da or greater, 400,000 Da or greater, 500,000 Da or greater, 600,000 Da or greater, 700,000 Da or greater, 800,000 Da or greater, 900,000 Da or greater, or 1,000,000 Da or greater). In some embodiments, the weight average molecular weight of the copolymers can be 1,000,000 Da or less (e.g., 900,000 Da or less, 800,000 Da or less, 700,000 Da or less, 600,000 Da or less, 500,000 Da or less, 400,000 Da or less, 300,000 Da or less, 200,000 Da or less, 150,000 Da or less, 100,000 Da or less, 75,000 Da or less, or 50,000 Da or less). In some embodiments, the weight average molecular weight of the copolymers can be from 100,000 Da to 1,000,000 Da.

In some embodiments, the copolymer composition disclosed herein is a gel. Polymerization of the monomers in the absence of the chain transfer agent tend to increase the gel content of the resulting copolymer. In some embodiments, the chain transfer agent can be present in an amount sufficient to reduce the gel content of the copolymer by 5% or greater (for example, 8% or greater, 10% or greater, 15% or greater, 20% or greater, or 25% or greater), compared to a copolymer polymerized using identical monomers in the absence of the chain transfer agent.

In some embodiments, the copolymer compositions disclosed herein have a gel content of from 0% to 95% (e.g., from 5% to 95% or from 10% to 95%). The gel content of the copolymer compositions can depend on the molecular weight of the copolymers in the composition. In certain embodiments, the copolymer compositions have a gel content of 5% or greater, 10% or greater, 15% or greater, 20% or greater, 30% or greater, 40% or greater, 50% or greater, 60% or greater, 75% or greater, 80% or greater, 85% or greater, or 90% or greater. In certain embodiments, the copolymer compositions have a gel content of 95% or less, 85% or less, 75% or less, 70% or less, 65% or less, 60% or less, 55% or less, or 50% or less.

The copolymers can be produced as a dispersion that includes, as a disperse phase, particles of the copolymers dispersed in water. The copolymers can be present in the dispersion in varying amounts so as to provide a resultant composition with the desired properties for a particular application. For example, the copolymer dispersion can be prepared with a total solids content of from 20% to 70% by weight (e.g., 25% to 65% by weight, 35% to 60% by weight, or 40% to 55% by weight). In some embodiments, the copolymer dispersion can have a total solids content of 40% or greater by weight. Despite the higher solids content of the aqueous dispersions, the aqueous dispersions disclosed herein can have a viscosity of 40 cP to 5,000 cP (e.g., from 100-4,000 cP, from 150-3,000 cP, from 150-1,000 cP, from 150-500 cP) at 20° C. The viscosity can be measured using a Brookfield type viscometer with a #3 spindle at 50 rpm at 20° C.

In addition to the copolymer, the dispersion can include a surfactant (emulsifier). The surfactant can include nonionic surfactants, anionic surfactants, cationic surfactants, amphoteric surfactants, or a mixture thereof. In some embodiments, the surfactant can include a copolymerizable surfactant. In some embodiments, the surfactant can include oleic acid surfactants, alkyl sulfate surfactants, alkyl aryl disulfonate surfactants, or alkylbenzene sulfonic acid or sulfonate surfactants. Exemplary surfactant can include ammonium lauryl sulfate, sodium laureth-1 sulfate, sodium laureth-2-sulfate, and the corresponding ammonium salts, triethylamine lauryl sulfate, triethylamine laureth sulfate, triethanolamine lauryl sulfate, triethanolamine laureth sulfate, monoethanolamine lauryl sulfate, monoethanolamine laureth sulfate, diethanolamine lauryl sulfate, diethanolamine laureth sulfate, lauric monoglyceride sodium sulfate, sodium lauryl sulfate, sodium laureth sulfate, potassium lauryl sulfate, potassium laureth sulfate, sodium lauryl sarcosinate, sodium lauroyl sarcosinate, lauryl sarcosine, cocyl sarcosine, ammonium cocoyl sulfate, ammonium lauroyl sulfate, sodium cocoyl sulfate, sodium lauroyl sulfate, potassium cocoyl sulfate, monoethanolamine cocoyl sulfate, monoethanolamine lauryl sulfate, sodium tridecyl benzene sulfonate, sodium dodecyl benzene sulfonate, C12 (branched) sodium diphenyl oxide disulfonate, or combinations thereof. Examples of commercially available surfactants include Calfoam® ES-303, a sodium laureth sulfate, and Calfax® DB-45, a sodium dodecyl diphenyl oxide disulfonate, both available from Pilot Chemical Company (Cincinnati, OH), Disponil SDS, Polystep LAS-40, or combinations thereof. The amount of the surfactant employed can be from 0.01 to 5%, based on the total amount of the monomers to be polymerized. In some embodiments, the surfactant is provided in an amount less than 2% by weight. The surfactant can be included during polymerization of the copolymer. For example, the surfactant can be provided in the initial charge of the reactor, provided in the monomer feed stream, provided in an aqueous feed stream, provided in a pre-emulsion, provided in the initiator stream, or a combination thereof. The surfactant can also be provided as a separate continuous stream to the reactor.

The copolymer dispersions can be used in coating formulations. The coating formulations can further include one or more additives such as one or more coalescing aids/agents (coalescents), plasticizers, defoamers, additional surfactants, pH modifying agents, fillers, pigments, dispersing agents, thickeners, biocides, crosslinking agents (e.g., quick-setting additives, for example, polyamines such as polyethyleneimine), flame retardants, stabilizers, corrosion inhibitors, flattening agents, optical brighteners and fluorescent additives, curing agents, flow agents, wetting or spreading agents, leveling agents, hardeners, or combinations thereof. In some embodiments, the additive can be added to impart certain properties to the coating such as smoothness, whiteness, increased density or weight, decreased porosity, increased opacity, flatness, glossiness, decreased blocking resistance, barrier properties, and the like.

Suitable coalescing aids, which aid in film formation during drying, include ethylene glycol monomethyl ether, ethylene glycol monobutyl ether, ethylene glycol monoethyl ether acetate, ethylene glycol monobutyl ether acetate, diethylene glycol monobutyl ether, diethylene glycol monoethyl ether acetate, dipropylene glycol monomethyl ether, propylene glycol n-butyl ether, dipropylene glycol n-butyl ether, 2,2,4-trimethyl-1,3-pentanediol monoisobutyrate, or combinations thereof. In some embodiments, the coating formulations can include one or more coalescing aids such as propylene glycol n-butyl ether and/or dipropylene glycol n-butyl ether. The coalescing aids, if present, can be present in an amount of from greater than 0% to 30%, based on the dry weight of the copolymer. For example, the coalescing aid can be present in an amount of from 10% to 30%, from 15% to 30% or from 15% to 25%, based on the dry weight of the copolymer. In some embodiments, the coalescing aid can be included in coating formulations comprising a high Tg copolymer (that is a copolymer having a Tg greater than ambient temperature (e.g., 20° C.)). In these embodiments, the coalescing aid can be present in an effective amount to provide coating formulations having a Tg less than ambient temperature (e.g., 20° C.). In some embodiments, the compositions do not include a coalescing aid.

Defoamers serve to minimize frothing during mixing and/or application of the coating component. Suitable defoamers include organic defoamers such as mineral oils, silicone oils, and silica-based defoamers. Exemplary silicone oils include polysiloxanes, polydimethylsiloxanes, polyether modified polysiloxanes, or combinations thereof. Exemplary defoamers include BYK®-035, available from BYK USA Inc., the TEGO® series of defoamers, available from Evonik Industries, the DREWPLUS® series of defoamers, available from Ashland Inc., and FOAMASTER® NXZ, available from BASF Corporation.

Plasticizers can be added to the compositions to reduce the glass transition temperature (T_{g}) of the compositions below that of the drying temperature to allow for good film formation. Suitable plasticizers include diethylene glycol dibenzoate, dipropylene glycol dibenzoate, tripropylene glycol dibenzoate, butyl benzyl phthalate, or a combination thereof. Exemplary plasticizers include phthalate based plasticizers. The plasticizer can be present in an amount of from 1% to 15%, based on the dry weight of the copolymer. For example, the plasticizer can be present in an amount of from 5% to 15% or from 7% to 15%, based on the dry weight of the copolymer. In some embodiments, the plasticizer can be present in an effective amount to provide coating formulations having a Tg less than ambient temperature (e.g., 20° C.). In some embodiments, the compositions do not include a plasticizer.

The compositions can further include a quick setting additive. The quick setting additive can decrease the setting time of the compositions. Exemplary quick setting additives suitable for use in the compositions described herein includes polyamines (i.e., polymers formed from either an amine-group containing monomer or an imine monomer as polymerized units such as aminoalkyl vinyl ether or sulfides; acrylamide or acrylic esters, such as dimethylaminoethyl(meth)acrylate; N-(meth)acryloxyalkyl-oxazolidines such as poly(oxazolidinylethyl methacrylate), N-(meth)acryloxyalkyltetrahydro-1,3-oxazines, and monomers that readily generate amines by hydrolysis). Suitable polyamines can include, for example, poly(oxazolidinylethyl methacrylate), poly(vinylamine), or polyalkyleneimine (e.g., polyethyleneimine). In some embodiments, the quick setting additive can include a derivatized polyamine such as an alkoxylated polyalkyleneimine (e.g., ethoxylated polyethyleneimine). Suitable derivatized polyamines are disclosed in U.S. Patent Application No. 2015/0259559 which is hereby incorporated herein by reference in its entirety.

The derivatized polyamines can include polyamines in which some number of the primary and/or secondary amine groups have been covalently modified to replace one or more hydrogen atoms with a non-hydrogen moiety (R). In some embodiments, the derivatized polyamines include alkoxylated polyamine groups. In certain embodiments, the composition contains an ethoxylated polyethyleneimine, a propoxylated polyethyleneimine, a butoxylated polyethyleneimine, or a combination thereof. In some embodiments, the derivatized polyamines include an alkylated polyalkyleneimine (e.g., an alkylated polyethyleneimine or an alkylated polyvinylamine), a hydroxyalkylated polyalkyleneimine (e.g., a hydroxalkylated polyethyleneimine or a hydroxyalkylated polyvinylamine), an acylated polyalkylencimine (e.g., an acylated polyethyleneimine or an acylated polyvinylamine), or a combination thereof.

Derivatized polyamines are generally incorporated into the compositions in amounts less than 10% by weight, based on the dry weight of the copolymer. The amount of derivatized polyamine present in the composition can be selected in view of the identity of the derivatized polyamine, the nature of the copolymer present in the composition, and the desired setting time of the composition. In some embodiments, the polyamine such as the derivatized polyamine can be present in the composition at between 0.1% by weight and 5% by weight, based on the dry weight of the copolymer. In certain embodiments, the polyamine can be present in the composition at between 0.5% by weight and 2.5% by weight, based on the dry weight of the copolymer.

Pigments that can be included in the compositions can be selected from TiO₂ (in both anastase and rutile forms), clay (aluminum silicate), CaCO₃ (in both ground and precipitated forms), aluminum oxide, silicon dioxide, magnesium oxide, talc (magnesium silicate), barytes (barium sulfate), zinc oxide, zinc sulfite, sodium oxide, potassium oxide and mixtures thereof. Examples of commercially available titanium dioxide pigments are KRONOS® 2101, KRONOS® 2310, available from Kronos WorldWide, Inc., TI-PURE® R-900, available from DuPont, or TIONA® ATI commercially available from Millennium Inorganic Chemicals. Titanium dioxide is also available in concentrated dispersion form. An example of a titanium dioxide dispersion is KRONOS® 4311, also available from Kronos WorldWide, Inc. Suitable pigment blends of metal oxides are sold under the marks MINEX® (oxides of silicon, aluminum, sodium and potassium commercially available from Unimin Specialty Minerals), CELITE® (aluminum oxide and silicon dioxide commercially available from Celite Company), and ATOMITE® (commercially available from Imerys Performance Minerals). Exemplary fillers also include clays such as attapulgite clays and kaolin clays including those sold under the ATTAGEL® and ANSILEX® marks (commercially available from BASF Corporation). Additional fillers include nepheline syenite, (25% nepheline, 55% sodium feldspar, and 20% potassium feldspar), feldspar (an aluminosilicate), diatomaceous earth, calcined diatomaceous earth, talc (hydrated magnesium silicate), aluminosilicates, silica (silicon dioxide), alumina (aluminum oxide), mica (hydrous aluminum potassium silicate), pyrophyllite (aluminum silicate hydroxide), perlite, baryte (barium sulfate), Wollastonite (calcium metasilicate), and combinations thereof. More preferably, the at least one filler includes TiO₂, CaCO₃, and/or a clay.

Examples of suitable thickeners include hydrophobically modified ethylene oxide urethane (HEUR) polymers, hydrophobically modified alkali soluble emulsion (HASE) polymers, hydrophobically modified hydroxyethyl celluloses (HMHECs), hydrophobically modified polyacrylamide, and combinations thereof. HEUR polymers are linear reaction products of diisocyanates with polyethylene oxide end-capped with hydrophobic hydrocarbon groups. HASE polymers are homopolymers of (meth)acrylic acid, or copolymers of (meth)acrylic acid, (meth)acrylate esters, or maleic acid modified with hydrophobic vinyl monomers. HMHECs include hydroxyethyl cellulose modified with hydrophobic alkyl chains. Hydrophobically modified polyacrylamides include copolymers of acrylamide with acrylamide modified with hydrophobic alkyl chains (N-alkyl acrylamide). In certain embodiments, the coating composition includes a hydrophobically modified hydroxyethyl cellulose thickener. Other suitable thickeners that can be used in the coating compositions can include acrylic copolymer dispersions sold under the STEROCOLL™ and LATEKOLL™ trademarks from BASF Corporation, Florham Park, NJ; urethanes thickeners sold under the RHEOVIS™ trademark (e.g., Rheovis PU 1214); hydroxyethyl cellulose; guar gum; carrageenan; xanthan; acetan; konjac; mannan; xyloglucan; and mixtures thereof. The thickeners can be added to the composition formulation as an aqueous dispersion or emulsion, or as a solid powder. In some embodiments, the thickeners can be added to the composition formulation to produce a viscosity of from 20 Pa·s to 50 Pa·s (i.e., from 20,000 cP to 50,000 cP) at 20° C. The viscosity can be measured using a Brookfield type viscometer with a #3 spindle at 50 rpm at 20° C.

Examples of suitable pH modifying agents include bases such as sodium hydroxide, potassium hydroxide, amino alcohols, monoethanolamine (MEA), diethanolamine (DEA), 2-(2-aminoethoxy)ethanol, diisopropanolamine (DIPA), 1-amino-2-propanol (AMP), ammonia, and combinations thereof. In some embodiments, the compositions do not include an ammonia-based pH modifier. The pH of the dispersion can be greater than 7. For example, the pH can be 7.5 or greater, 8.0 or greater, 8.5 of greater, or 9.0 or greater.

Suitable biocides can be incorporated to inhibit the growth of bacteria and other microbes in the coating composition during storage. Exemplary biocides include 2-[(hydroxymethyl)amino]ethanol, 2-[(hydroxymethyl)amino]2-methyl-1-propanol, o-phenylphenol, sodium salt, 1,2-benzisothiazolin-3-one, 2-methyl-4-isothiazolin-3-one (MIT), 5-chloro2-methyland-4-isothiazolin-3-one (CIT), 2-octyl-4-isothiazolin-3-one (OIT), 4,5-dichloro-2-n-octyl-3-isothiazolone, as well as acceptable salts and combinations thereof. Suitable biocides also include biocides that inhibit the growth of mold, mildew, and spores thereof in the coating. Examples of mildewcides include 2-(thiocyanomethylthio)benzothiazole, 3-iodo-2-propynyl butyl carbamate, 2,4,5,6-tetrachloroisophthalonitrile, 2-(4-thiazolyl)benzimidazole, 2-N-octyl4-isothiazolin-3-one, diiodomethyl p-tolyl sulfone, as well as acceptable salts and combinations thereof. In certain embodiments, the coating composition contains 1,2-benzisothiazolin-3-one or a salt thereof. Biocides of this type include PROXEL® BD20, commercially available from Arch Chemicals, Inc. The biocide can alternatively be applied as a film to the coating and a commercially available film-forming biocide is Zinc Omadine® commercially available from Arch Chemicals, Inc.

Exemplary co-solvents and humectants include ethylene glycol, propylene glycol, diethylene glycol, and combinations thereof. Exemplary dispersants can include sodium polyacrylates in aqueous solution such as those sold under the DARVAN trademark by R.T. Vanderbilt Co., Norwalk, CT.

The copolymer can be present in an amount of 60% by weight or greater, based on the total amount of polymers in the compositions described herein. For example, the copolymer can be present in an amount of 65% by weight or greater, 70% by weight or greater, 75% by weight or greater, 80% by weight or greater, 85% by weight or greater, 90% by weight or greater, 95% by weight or greater, 95% by weight or greater, or up to 100% by weight or greater, based on the total amount of polymers in the compositions described herein.

### Methods

The copolymers and compositions disclosed herein can be prepared by any polymerization method known in the art. In some embodiments, the copolymers disclosed herein are prepared by a dispersion, a mini-emulsion, or an emulsion polymerization. The copolymers disclosed herein can be prepared, for instance, by polymerizing the vinyl aromatic monomer, the diene monomer, the acid monomer, optionally additional monomers, and the chain transfer agent using free-radical aqueous emulsion polymerization. In some embodiments, the polymerization medium is an aqueous medium. Thus, the emulsion polymerization medium can include an aqueous emulsion comprising water, a vinyl aromatic monomer, a diene monomer, an acid monomer, optionally additional monomers, and the chain transfer agent. Solvents other than water can be used in the emulsion.

The emulsion polymerization can be carried out either as a batch, semi-batch, or continuous process. In some embodiments, a portion of the monomers can be heated to the polymerization temperature and partially polymerized, and the remainder of the polymerization batch can be subsequently fed to the polymerization zone continuously, in steps or with superposition of a concentration gradient. The process can use a single reactor or a series of reactors as would be readily understood by those skilled in the art. For example, a review of heterophase polymerization techniques is provided in M. Antonelli and K. Tauer, Macromol. Chem. Phys. 2003, vol. 204, p 207-19.

A copolymer dispersion can be prepared by first charging a reactor with water, a vinyl aromatic monomer, a diene monomer, an acid monomer, optionally additional monomers, and a chain transfer agent. A seed latex, though optional, can be included in the reactor to help initiate polymerization and helps produce a polymer having a consistent particle size. Any seed latex appropriate for the specific monomer reaction can be used such as a polystyrene seed. The initial charge can also include a chelating or complexing agent such as ethylenediamine tetraacetic acid (EDTA). Other compounds such as buffers can be added to the reactor to provide the desired pH for the emulsion polymerization reaction. For example, bases or basic salts such as KOH or tetrasodium pyrophosphate can be used to increase the pH whereas acids or acidic salts can be used to decrease the pH. The initial charge can then be heated to a temperature at or near the reaction temperature. The reaction temperature can be, for example, between 50° C. and 100° C. (e.g., between 55° C. and 95° C., between 58° C. and 90° C., between 61° C. and 85° C., between 65° C. and 80° C., or between 68° C. and 75° C.).

After the initial charge, the monomers that are to be used in the polymerization can be continuously fed to the reactor in one or more monomer feed streams. The monomers can be supplied as a pre-emulsion in an aqueous medium. An initiator feed stream can also be continuously added to the reactor at the time the monomer feed stream is added although it may also be desirable to include at least a portion of the initiator solution to the reactor before adding a monomer pre-emulsion if one is used in the process. The monomer and initiator feed streams are typically continuously added to the reactor over a predetermined period of time (e.g., 1.5-5 hours) to cause polymerization of the monomers and to thereby produce the polymer dispersion. A nonionic surfactant and any other surfactants can be added at this time as part of either the monomer stream or the initiator feed stream although they can be provided in a separate feed stream. Furthermore, one or more buffers can be included in either the monomer or initiator feed streams or provided in a separate feed stream to modify or maintain the pH of the reactor.

As mentioned above, the monomer feed stream can include one or more monomers (e.g., a vinyl aromatic monomer, a diene monomer, an acid monomer, optionally additional monomers, and a chain transfer). The monomers can be fed in one or more feed streams with each stream including one or more of the monomers being used in the polymerization process. For example, the vinyl aromatic monomer, the diene monomer, the acid monomer, the optionally additional monomers, and the chain transfer agent can be provided in separate monomer feed streams or can be added as a pre-emulsion. It can also be advantageous to delay the feed of certain monomers to provide certain polymer properties or to provide a layered or multiphase structure (e.g., a core/shell structure). In some embodiments, the copolymers are polymerized in multiple stages to produce particles having multiple phases. In some embodiments, the copolymers are polymerized in a single stage to produce a single phase particle.

The initiator feed stream can include at least one initiator or initiator system that is used to cause the polymerization of the monomers in the monomer feed stream. The initiator stream can also include water and other desired components appropriate for the monomer reaction to be initiated. The initiator can be any initiator known in the art for use in emulsion polymerization such as azo initiators; ammonium, potassium or sodium persulfate; or a redox system that typically includes an oxidant and a reducing agent. Commonly used redox initiation systems are described, e.g., by A. S. Sarac in Progress in Polymer Science 24, 1149-1204 (1999). Exemplary initiators include azo initiators and aqueous solutions of sodium persulfate. The initiator stream can optionally include one or more buffers or pH regulators. In some embodiments, ammonia is not used during polymerization of the copolymers. Accordingly, the copolymer compositions can be free or substantially free of ammonia.

In addition to the monomers and initiator, a surfactant (i.e., emulsifier) such as those described herein can be fed to the reactor. The surfactant can be provided in the initial charge of the reactor, provided in the monomer feed stream, provided in an aqueous feed stream, provided in a pre-emulsion, provided in the initiator stream, or a combination thereof. The surfactant can also be provided as a separate continuous stream to the reactor. The surfactant can be provided in an amount of 1%-5% by weight, based on the total weight of monomer and chain transfer agent. In some embodiments, the surfactant is provided in an amount less than 2% by weight.

Once polymerization is completed, the polymer dispersion can be chemically stripped thereby decreasing its residual monomer content. This stripping process can include a chemical stripping step and/or a physical stripping step. In some embodiments, the polymer dispersion is chemically stripped by continuously adding an oxidant such as a peroxide (e.g., t-butylhydroperoxide) and a reducing agent (e.g., sodium acetone bisulfite), or another redox pair to the reactor at an elevated temperature and for a predetermined period of time (e.g., 0.5 hours). Suitable redox pairs are described by A. S. Sarac in Progress in Polymer Science 24, 1149-1204 (1999). An optional defoamer can also be added if needed before or during the stripping step. In a physical stripping step, a water or steam flush can be used to further eliminate the non-polymerized monomers in the dispersion. Once the stripping step is completed, the pH of the polymer dispersion can be adjusted and a biocide or other additives can be added. Deformers, coalescing aids, or a plasticizer can be added after the stripping step or at a later time if desired. Cationic, anionic, and/or amphoteric surfactants or polyelectrolytes may optionally be added after the stripping step or at a later time if desired in the end product to provide a cationic or anionic polymer dispersion.

Once the polymerization reaction is complete, and the stripping step is completed, the temperature of the reactor can be reduced.

As disclosed herein, the copolymers can be used in coating compositions. The coating compositions can be used for several applications, including membranes, films, adhesives, paints, coatings, carpet backing, foams, textiles, sound absorbing compounds, tape joint compounds, asphalt-aggregate mixtures, waterproofing membranes, and asphalt roofing compounds. In some embodiments, the copolymer can be formulated for use in seam coatings. In some embodiments, the copolymer can be formulated for use in paint, such as a semi-gloss paint. In some embodiments, the copolymer can be formulated for use in adhesive. In some embodiments, the adhesive can be a pressure sensitive adhesive. An adhesive can include the copolymer with one or more additives such as a surfactant. In some embodiments, the coating can be provided as a film. A film can include the copolymer with one or more coalescing aids and/or one or more plasticizers. In some embodiments, the coating can be provided as a membrane. A membrane can include the copolymer with one or more of a binder, a filler, a cementitious material, a thickener, or a combination thereof. Generally, coatings are formed by applying the coating composition as described herein to a surface, and allowing the coating to dry to form a dried coating. The surface can be, for example, a seam, a PVC pipe, a concrete, a brick, a mortar, an asphalt, a granulated asphaltic cap sheet, a carpet, a granule, a pavement, a ceiling tile, a sport surface, an exterior insulation and finish system (EIFS), a spray polyurethane foam surface, a thermoplastic polyolefin surface, an ethylene-propylene diene monomer (EPDM) surface, a modified bitumen surface, a roof, a wall, a storage tank, an expanded polystyrene (EPS) board, a wood, a plywood, an oriented strand board (OSB), a metal sheathing, an interior sheathing or exterior sheathing (including gypsum board or cement board), a siding, or another coating surface (in the case of recoating applications).

The coating composition can be applied to a surface by any suitable coating technique, including spraying, rolling, brushing, or spreading. The composition can be applied in a single coat, or in multiple sequential coats (e.g., in two coats or in three coats) as required for a particular application. Generally, the coating composition is allowed to dry under ambient conditions. However, in certain embodiments, the coating composition can be dried, for example, by heating and/or by circulating air over the coating. The coating can have a thickness of 2 mils or greater, such as 5 mils or greater, 10 mils or greater, 15 mils or greater, 20 mils or greater, or 25 mils or greater. In some embodiments, the coating can have a thickness of 30 mils or less, such as 25 mils or less, 20 mils or less, 15 mils or less, 10 mils or less, or 5 mils or less.

In some embodiments, the coating when dried, has a water absorption of less than 10% by weight of the coating at 168 hours, according to a modified DIN 53-495 test. For example, the coating can have a water absorption of less than 8% by weight, less than 6% by weight, less than 5% by weight, less than 4% by weight, less than 3% by weight, less than 2.5% by weight, less than 2% by weight, less than 1.5% by weight, or less than 1% by weight of the coating, at 168 hours, according to a modified DIN 53-495 test.

The modified DIN 53-495 test includes cutting six 1⅛″ circular discs or 2×2 inch squares from the membrane being tested. Three of the discs (or squares) are weighed and placed into a container with de-ionized water and the other three weighed and placed in a separate container filled with de-ionized water that has the pH adjusted to 11 with a base. After 24 hours, each disc (or square) is removed, dried, and weighed within one minute to prevent moisture loss. The disc (or square) is placed back into the container it originally came from and the test repeated at various intervals as desired (such as at 48 hours, 72 hours, 96 hours, 120 hours, 144 hours, or 168 hours). The % water absorption is calculated using the equation: W_{abs}=(m₁−mᵢ)/mᵢ; wherein mᵢ is the weight of the sample after 24 or the selected time; mᵢ is the weight of sample initially; and W_{abs} is the water absorption in %.

In some embodiments, the coating can have a wet shear bond strength of at least 65 psi when used to bond a ceramic tile to a surface according to ANSI A 136.1 (2009). For example, the coating can have a wet shear bond strength of at least 65 psi, at least 70 psi, at least 80 psi, at least 90 psi, at least 100 psi, at least 120 psi, at least 150 psi, at least 160 psi, at least 175 psi, at least 180 psi, when used to bond a ceramic tile to a surface according to ANSI A 136.1 (2009).

In some embodiments, the coating can have a dry shear bond strength of at least 140 psi when used to bond a ceramic tile to a surface according to ANSI A 136.1 (2009). For example, the coating can have a dry shear bond strength of at least 145 psi, at least 150 psi, at least 160 psi, at least 175 psi, at least 180 psi, at least 190 psi, or at least 200 psi when used to bond a ceramic tile to a surface according to ANSI A 136.1 (2009).

In some embodiments, the coating can have a tensile strength of greater than 275 psi as set forth in ASTM D-2370 at 23° C. For example, the coating can have a tensile strength of 300 psi or greater, 325 psi or greater, 350 psi or greater, 375 psi or greater, 400 psi or greater, or 425 psi or greater as set forth in ASTM D-2370 at 23° C. In some embodiments, the coating can have a tensile strength of from greater than 275 psi to 500 psi, from greater than 275 psi to 450 psi, from 300 psi to 500 psi, or from 325 psi to 500 psi, as set forth in ASTM D-2370 at 23° C.

In some embodiments, the coating can have an elongation at break of greater than 180% as set forth in ASTM D-2370 at 23° C. For example, the coating can have an elongation at break of 190% or greater, of 200% or greater, 210% or greater, 220% or greater, 230% or greater, 235% or greater, or 240% or greater as set forth in ASTM D-2370 at 23° C. In some embodiments, the coating can have an elongation at break of from greater than 180% to 400%, from greater than 190% to 400%, from greater than 200% to 400 psi, or from greater than 210% to 400%, as set forth in ASTM D-2370 at 23° C.

In some embodiments, the coating can have a wet peel strength of at least 6 lb_{f} according to a modified ASTM C794-93 test. For example, the coating can have a wet peel strength of at least 6.5 lb_{f}, at least 7.0 lb_{f}, at least 7.5 lb_{f}, at least 8.0 lb_{f}, at least 8.5 lb_{f}, or at least 9.0 lb_{f}, according to the modified ASTM C794-93 test. In some embodiments, the coating can have a wet peel strength of from 6 lb_{f} to 10 lb_{f}, from 6.5 lb_{f} to 10 lb_{f}, or from 7.0 lb_{f} to 9.5 lb_{f}, according to the modified ASTM C794-93 test.

In some embodiments, the coating can have a dry peel strength of at least 6.5 lb_{f} according to a modified ASTM C794-93 test. For example, the coating can have a dry peel strength of at least 7.0 lb_{f}, at least 7.5 lb_{f}, or at least 8.0 lb_{f}, according to the modified ASTM C794-93 test. In some embodiments, the coating can have a dry peel strength of from 6.5 lb_{f} to 10 lb_{f}, from 7.0 lb_{f} to 10 lb_{f}, or from 7.0 lb_{f} to 8.5 lb_{f}, according to the modified ASTM C794-93 test.

The modified ASTM C794-93 test determines the peel values from substrates such as a polyurethane foam or a galvanized steel. Substrate blocks having a ¾″ thickness or slightly less was cut out and rinsed under running water to remove all dust from sawing and handling preparations. The galvanized steel substrate can be cleaned with a solvent such as acetone or methyl ethyl ketone. A smooth coat of the wet coating formulation is applied onto the surface of the dried substrate, targeting a consistent weight, such as about 6±1 grams. The initial coat is allowed to cure overnight (16±2 hours) at controlled temperature and humidity (CTH) conditions. A thin layer of fresh coating is then applied to the cured surface. Six (6) inches of a 15±1 inch by 1±0.03-inch mesh screen (such as Pet-D-Fence polyester screen or similar) is embedded into the wet coating down the long center of the coated substrate followed by application of the coating formulation such that the screen becomes embedded in the coating formulation. The sample is allowed to cure again under CTH conditions for 14 days. A strip (about 1″ wide) is cut from the lower edge of the test substrate. The peel is then started by hand. The substrate is then placed into a tensile tester so that the screen can be peeled off at 180°±3° @ 2″/min±⅛″. At least 1.5 inch of the screen is pulled from the substrate and the force exerted (“peak average”) as well as the nature of the separation from the panel (adhesive or cohesive failure) is recorded. The remaining portion of the sample is completely submerged in room temperature water, and soaked under CTH conditions for 7 days±12 hours. The sample is then removed from the water and the peel strength determined as described above.

In some embodiments, the coating can have a permeance of less than 0.20 perm, according to ASTM E-96 A. For example, the coating can have a permeance of 0.15 or less perm, or 0.10 or less perm, according to ASTM E-96 A. In some embodiments, the coating can have a permeance of less than 0.40 perm, according to ASTM E-96 B. For example, the coating can have a permeance of 0.30 or less perm, or 0.20 or less perm, according to ASTM E-96 B.

In some embodiments, the compositions disclosed herein are especially useful in waterproof coatings. For instance, the compositions disclosed herein can be used as seam coatings, e.g., seam seals on paper, plastic, or metal substrates. The compositions disclosed herein are also useful in adhesives having improved film clarity and blush resistance. The term “blush” or “blushing” refers to a cured coating (including polymer films) or laminate whose normally visible exterior surface exhibits, after extended immersion in water, a change in coloration (e.g., as a decrease in saturation, change in hue, decrease in lightness, or increase in film opacity or cloudiness) discernible by a typical observer under normal indoor illumination. In some embodiments, coating compositions comprising copolymers polymerized in the presence of a chain transfer agent and optionally, one or more coalescing aids as described herein can exhibit blush resistance (or will not blush) after 16 hours of exposure to 25° C. water. For example, coating compositions comprising copolymers and one or more coalescing aids described herein can have a blush resistance of at least 17 hours, at least 18 hours, at least 19 hours, at least 20 hours, at least 22 hours, or at least 24 hours when exposed to 25° C. water. The compositions can exhibit improved film clarity and blush resistance whether in the presence or absence of coalescing aids. The blushing resistance can be determined as described herein. For example, a 2 mil neat polymer film of the copolymer dispersion can be prepared. A sufficient amount of de-ionized water (about 4 drops or more) is then placed on the dried polymer film. The water is covered with a suitable cover to prevent evaporation. Any change in the color or opacity of the polymer film is recorded at appropriate intervals (such at 0 min, 15 mins, 30 mins, 1 hr, 2 hrs, 4 hrs, and 24 hrs). The film is then compared to a film discoloration reference chart.

In some embodiments, the compositions disclosed herein can be used in decorative or water resistant coatings. For example, the compositions disclosed herein when formulated into water resistant coatings that are applied on porous walls provide for protection against leakage for hydrostatic pressures of 4 psi or higher (e.g., 5 psi or higher, 10 psi or higher, 12 psi or higher, 15 psi or higher, 17 psi or higher, or 20 psi or higher). In some embodiments, the copolymers disclosed herein when formulated into water resistant coatings on porous walls provide protection against leakage for hydrostatic pressures of up to 20 psi such as from 0.5 psi to 20 psi, from 4 psi to 20 psi or from 10 psi to 20 psi. The hydrostatic resistance can be determined in accordance with a J-tube test or ASTM D7088-08.

By way of non-limiting illustration, examples of certain embodiments of the present disclosure are given below.

### EXAMPLES

### Example 1

Preparation of copolymer dispersions: Copolymer dispersions derived from styrene, butadiene, an acid monomer, and a chain transfer agent as described in Table 1, were produced. The dispersions comprised from about 51% to about 53% solids. Lipaton™ SB 5925 (available from Synthomer plc) was used as a control in the examples.

TABLE 1
Composition of copolymer dispersions.

| | | | | | IA/AA | | |
|---|---|---|---|---|---|---|---|
| | | Stvrene | Butadiene | t-ddm | Acid | Other | Surfactant |
| Sample ID | Tg, ° C. | (pphm) | (pphm) | (pphm) | (pphm) | (pphm) | (pphm) |
| 1 | — | 61.3 | 36 | 1.5 | 0.9/1.8 | 0.125 | 0.37 Calfoam |
| | | | | | | VTEO | ES-303 |
| 2 | — | 58.3 | 39 | 1.5 | 0.9/1.8 | — | 0.37 Calfoam |
| | | | | | | | ES-303 |
| 3 | — | 61.3 | 36 | 0.2/1.5 | 0.9/1.8 | — | 0.37 Calfoam |
| | | | | | | | ES-303 |
| 4 | — | 61.3 | 36 | 2.2 | 0.9/1.8 | — | 0.37 Calfoam |
| | | | | | | | ES-303 |
| 5 - pH adi w/ | — | 61.3 | 36 | 2.2 | 0.9/1.8 | — | 0.37 Calfoam |
| ammonia) | | | | | | | ES-303 |
| 6 | — | 61.3 | 36 | 1.5 | 0.9/1.8 | — | 0.37 Calfoam |
| | | | | | | | ES-303 |
| 7 | — | 61.6 | 36.3 | 1.5 | 2.1/0 | — | 0.37 Calfoam |
| | | | | | | | ES-303 |
| 8 | — | 55.6 | 42.3 | 1.5 | 2.1/0 | — | 0.37 Polystep |
| | | | | | | | LAS-40 |
| 9 | — | 58.75 | 39 | 1.82 | 1.75/0 | 0.5 AM | 0.93 Calfax- |
| | | | | | | | DB 45 |
| 10 | — | 55.6 | 41.7 | 1.5 | 0.9/1.8 | — | 0.37 Calfoam |
| | | | | | | | ES-303 |
| 11 | — | 64 | 34 | 1.82 | 1.5/0 | 0.5 AM | 1.40 Polystep |
| | | | | | | | LAS-40 |
| 12 | −3 | 55.6 | 42.3 | 1.5 | 2.1/0 | — | 0.37 Calfoam |
| | | | | | | | ES-303 |
| 13 | −7 | 54 | 44 | 1.82 | 1.5/0 | 0.5 AM | 0.93 Calfoam |
| | | | | | | | ES-303 |
| 14 | −6 | 54 | 44 | 1.82 | 1.5/0 | 0.5 AM | 0.93 Calfoam |
| | | | | | | | ES-303 |
| 15 | 11 | 64 | 34 | 1.82 | 1.5/0 | 0.5 AM | 0.93 Calfoam |
| | | | | | | | ES-303 |
| 16 | −8 | 53 | 45 | 0.94 | 2.0/0 | — | 0.50 Calfoam |
| | | | | | | | ES-303 |
| 17 | 14 | 64 | 34 | 1.82 | 1.5/0 | 0.5 AM | 0.93 Calfoam |
| | | | | | | | ES-303 |
| 18 | — | 61.3 | 36 | 1.5 | 0.9/1.8 | — | 0.37 Calfoam |
| | | | | | | | ES-303 |
| 19 | 27 | 42.4 | 54.5 | 1.1 | 2.7/0 | 0.375 | 3.5 Calfoam |
| | | | | | | nMA | ES-303 |
| 20 | — | 63.8 | 34 | 1.82 | 1.75/0 | 0.5 AM | 0.93 Polystep |
| | | | | | | | LAS-40 |
| 21 | — | 58 | 40 | 0.94 | 2.0/0 | — | 0.50 Calfoam |
| | | | | | | | ES-303 |
| 22 | — | 55.6 | 42.3 | 1.5 | 2.1/0 | — | 0.37 Calfoam |
| | | | | | | | ES-303 |

VTEO—Dynasylan ® vinyltriethoxysilane
AM—acrylamide
nMA—n-methylol acrylamide

Waterproofing formulations: Waterproofing binders were formulated from the copolymers described in Table 2, calcium carbonate as a filler (available from BASF), a surfactant/dispersant, a defoamer, and a rheology modifier, and pH of the formulation was adjusted to 8. The tensile strength and percent elongation at break of the dry and wet binder formulations were determined.

TABLE 2
Waterproofing Binder

| | Properties | | | | |
|---|---|---|---|---|---|
| | DRY | | WET | | |
| | Tensile, | Elongation, | Tensile, | Elongation, | |
| Sample | psi | % | psi | % | Tg, C. |
| 18 | 450 | 170 | 300 | 350 | 12 |
| 2 | 275 | 435 | 180 | 700 | 5 |
| 5 | 370 | 405 | 340 | 470 | 8 |
| Lipaton ™ S B | 300 | 415 | 265 | 590 | 7 |
| 5925 | | | | | |

Blush resistance: The blush resistance of membranes formed from the copolymer dispersions were determined. The membranes were prepared as described above with respect to the waterproofing formulations. The thickness of the membranes were 30 mils. A sufficient amount of de-ionized water (about 4 drops or more) was placed on the dried copolymer membrane. The water was covered to prevent evaporation. At appropriate intervals (such at 1 hr, 4 hrs, and 24 hrs), any change in the color or opacity of the membranes were observed and recorded. The membranes were compared to a reference chart, the results of which are summarized in Table 3.

TABLE 3
Blushing resistance of formulated copolymer membranes.

| | | | | | | | | | Lipaton ™ | | |
|---|---|---|---|---|---|---|---|---|---|---|---|
| Time | | 12 | 12 | 16 | 19 | 8 | 9 | 11 | SB 5925 | 7 | 10 |
| 1 | Hr | 0 | 0 | 1 | 0 | 0 | 0 | 0 | 0 | 0 | 0 |
| 4 | Hrs | 0 | 1 | 1 | 1 | 0 | 0 | 1 | 0 | <1 | 0 |
| 24 | Hrs | 0 | 2 | 1 | 1 | 1 | 2 | 3 | 1 | 1 | <1 |

Blushing Scale: 0 → none; 1 → very slight blushing; 2 → some blushing; 3 → blushing.

Water Absorption: The water absorption of membranes formed from the copolymer dispersions were determined. The membranes were prepared as described above with respect to the blushing resistance. The water absorption was determined according to a modified DIN 53-495 test. In particular, six 1⅛″ circular discs or 2×2 inch squares were cut out from each membrane being tested. Three of the discs (or squares) were weighed and placed into a container with de-ionized water and the other three weighed and placed in separate containers filled with de-ionized water that has had the pH adjusted to 11 with 20% KOH or other alkali. After 24 hours, the discs (or squares) were removed, patted dry with a non-fuzzing paper, and weighed. Note: The samples were reweighed within one minute to prevent moisture loss. The sample was placed back into the container it originally came from and the test repeated at various intervals (such as described in Table 4). The % water absorption was calculated using the equation: W_{abs}=(m₁−mᵢ)/mᵢ; wherein mᵢ is the weight of the sample after 24 or the selected time; mᵢ is the weight of sample initially; and W_{abs} is the water absorption in %. The results of the water absorption are summarized in Table 4.

TABLE 4
Water absorption of formulated membranes.

| Thickness | | |
|---|---|---|
| 30 mils dry | 25 mils dry | 20 mils dry |

Time

| | 24 | 168 | 24 | 168 | 24 | 168 |
|---|---|---|---|---|---|---|
| Sample | hours | hours | hours | hours | hours | hours |
| 12 | 2.9 | 6.7 | 9.8 | — | 9.8 | — |
| 15 | 2.8 | 6.7 | 7 | — | 7.6 | — |
| 20 | 3.6 | 7.9 | 6.5 | — | 6.9 | — |
| 7 | 2 | 5.1 | — | Blushed | — | — |
| 21 | — | — | 4.1 | 9.7 | 3.5 | 8.7 |

Water permeance: The water permeance of dry and wet membranes were determined. The water permeance and/or hydrostatic pressure resistance were determined using the standard water permeance test or a J-tube test, respectively as described below. The results of the water permeance are summarized in Table 5.

Standard Water Permeance: This procedure outlines a process for determining the water vapor transmission and permeability of the formulated membranes. Dried membrane samples having a thickness as described in Table 5 and determined using a caliper was obtained. The membrane was conditioned for a minimum of 24 hrs at standard conditions (72±2° F., 50±5% R.H.). Water vapor transmission test cups (permeability cups) were filled with water to an appropriate level using a syringe. In particular, Type I (inside diameter of 2.2 inches, depth 0.5 inches, outside diameter of 3.25 inches) and Type II (inside diameter of 2.2 inches, depth 0.375 inches, outside diameter of 3.25 inches) test cups were used. Both Type I cup and Type II cups had approximately 8 milliliters of water.

The test cups were then assembled by mounting a membrane sample between the rubber gasket and the ring of the test cup. The surface of the membrane sample that is directly exposed to the water was observed and recorded. (The default surface is the surface that is exposed to the air in the initial stages of drying). The assemblies were completed by placing the threaded cover on and tightening.

The test cups were then weighed, placed in a controlled temperature and humidity room, and the date, time, temperature and relative humidity over the duration of the test recorded. For normal or upright permeability, the cup was left with the film exposed to the ceiling for the duration of the test. For inverted permeability, the cup was left with the film facing the floor for the duration of the test. The cups were reweighed every 24 hours±15 minutes for a minimum of 4 days, or until the weight change versus time became constant.

The time, temperature, and relative humidity over the duration of the test as well as the weights and film thickness of the samples versus elapsed time and the final calculated permeability in both perms and metric units were recorded. ASTM D 1653-93 and ASTM E 96-95 can be used as a reference for the standard permeance test.

J-tube test: A pressure tube connected to a sample holder having an inner diameter of about 2 inches and an outer diameter of about 3 inches, with a means for introducing water from below the sample was used in the test. An extension tube was connected to the J-tube to permit a water head of 2 ft. with a cutoff valve or other suitable device at-the water inlet to the-pressure tube for isolating the sample until the desired head is reached.

The test sample (about 3×3 inches) was placed in the holder that has been previously filled with water. Care was taken to avoid trapped air between the sample and the water. This was done by filling the holder with water and sliding the specimen onto the holder in direct contact with the water. The tube was filled to achieve a 2 ft. hydrostatic head. The sample was observed at 10-min intervals for the first hour, and hourly intervals for the succeeding 7 h, after which the sample was left under hydrostatic pressure for 40 h and again examined.

Any evidence of wetness on top of the specimen or the formation of a droplet resulted in the sheeting sample to be rejected. The results were reported as pass or fail. ASTM D4068 can be used as a reference for determining the hydrostatic pressure resistance of the copolymers.

TABLE 5
Water permeance of formulated copolymer membranes using a J-Tube.

| | Properties | | | |
|---|---|---|---|---|
| Thickness | 30 mils dry | | 25 mils dry | 20 mils dry |
| | | Standard | J- | J- |
| | J-tube | Permeance, | tube | tube |
| Sample | test | perms | test | test |
| 12 | Pass | 0.56 | — | — |
| 12 | Pass | 1.24 | — | — |
| 17 | Pass | 0.40 | — | — |
| 16 | Pass | 0.77 | — | — |
| 8 | Pass | 1.08 | Pass | Pass |
| 7 | Pass | — | — | — |
| 10 | Pass | 1.36 | Pass | Pass |
| 21 | — | — | Pass | Pass |
| 6 | — | — | Pass | Pass |
| Lipaton ™ SB | Pass | 1.12 | — | — |
| 5925 | | | | |

Wet and dry shears: The wet and dry shear properties of the membranes were determined according to ANSI A 136.1 (2009). The results of the wet and dry shear properties are summarized in Tables 6 and 7. The methods were conducted in duplicate.

TABLE 6
Wet shear of formulated waterproofing binders.

| | Properties | | | | |
|---|---|---|---|---|---|
| | | | | Bond | Average |
| | | Bonded Tile | Maximum | Strength, | bond |
| Sample | | Area, in² | load, lb_{f} | psi | Strength |
| 17 | A | 13.8 | 2940 | 213 | 194 |
| | B | 13.8 | 2425 | 176 | |
| 16 | A | 13.8 | 2065 | 150 | 145 |
| | B | 13.8 | 1940 | 140 | |
| 22 | A | 13.8 | 1730 | 125 | 140 |
| | B | 13.8 | 2140 | 155 | |
| 22 (25:1) | A | 13.8 | 755 | — | 117 |
| | B | 13.8 | 1620 | 117 | |
| 23 | A | 13.8 | 2425 | 176 | 192 |
| | B | 13.8 | 2885 | 209 | |
| Lipaton ™ SB | A | 13.8 | 2160 | 156 | 153 |
| 5925 | B | 13.8 | 2075 | 150 | |

TABLE 7
Dry shear of formulated waterproofing binders.

| | Properties | | | | |
|---|---|---|---|---|---|
| | | | | Bond | Average |
| | | Bonded Tile | Maximum | Strength, | bond |
| Sample | | Area, in² | load, lb_{f} | psi | Strength |
| 17 | A | 13.8 | 2690 | 195 | 231 |
| | B | 13.8 | 3685 | 267 | |
| 16 | A | 13.8 | 785 | 56.8 | 66 |
| | B | 13.8 | 1035 | 75 | |
| 22 | A | 13.8 | 1500 | 109 | 87 |
| | B | 13.8 | 910 | 66 | |
| 22 (25:1) | A | 13.8 | 915 | 66 | 70 |
| | B | 13.8 | 1010 | 73 | |
| 23 | A | 13.8 | 2465 | 178 | 204 |
| | B | 13.8 | 3160 | 229 | |
| Lipaton ™ SB | A | 13.8 | 1225 | 89 | 95 |
| 5925 | B | 13.8 | 1405 | 102 | |

Seam coating formulation: An inventive latex copolymer (100 part dry weight; 188.7 parts wet weight) was combined with a defoamer (1.6 part dry weight; 1.8 parts wet weight), calcium carbonate as a filler (125 part dry weight; 125 parts wet weight), and a thickener (as needed to give a viscosity [spindle TE@5] of 40,000 cp) to form sample SC 1. The pH of the sample was adjusted to 8. The latex solids was about 53%. The formulation was always “whip mixed” to remove excess air. The properties of the seam coating formulation are summarized in Table 8.

Peel Strength: The wet and dry peel properties of the seam formulations were determined according to a modified ASTM C794-93 test. The procedure determines the peel values from substrates such as polyurethane foam and galvanized steel. Substrate blocks having a ¾″ thickness or slightly less was cut out and rinsed under running water to remove all dust from sawing and handling preparations. The galvanized steel substrate can be cleaned with a solvent such as acetone or MEK.

A smooth coat of the wet coating formulation was applied onto the surface of the dried substrate, targeting a consistent weight, such as 6±1 grams. The initial coat was allowed to cure overnight (16±2 hours) at CTH conditions. A thin layer of fresh coating was then applied to the cured surface. Six (6) inches of a 15±1 inch by 1±0.03-inch mesh screen (Pet-D-Fence polyester screen or similar) was embedded into the wet coating down the long center of the coated panel followed by application of the coating formulation in such a way that the screen becomes thoroughly embedded in the coating formulation. The sample was allowed to cure again under CTH conditions for 14 days.

A tensile tester was set up to carry out a 180° peel test @ 2″/min±⅛″. A strip (about 1″ wide) was cut from the lower edge of the test panel. The peel was then started by hand. The sample was then placed into the tensile tester so that the screen can be peeled off at 180°±3°. At least 1.5 inch of the screen was pulled from the panel and the force exerted (“peak average”) as well as the nature of the separation from the panel (adhesive or cohesive failure) were recorded.

The remaining portion of the sample was completely submerged in room temperature DI water, and soaked under CTH conditions for 7 days±12 hours. The sample was then removed from the water and the peel strength determined as described above.

TABLE 8
Properties of seam coating formulation.

| Latex | SC 1 |
|---|---|
| 7-day water absorption, % | 8.5 |
| Membrane tensile, psi | 468 |
| Membrane elongation, % | 220 |
| Wet Peel, lbf | 6.4 |
| Dry Peel, lbf | 7.8 |
| E96A Permeance, perms | 0.08 |
| E96B Permeance, perms | 0.2 |

SC 1—polymer of the invention

The compositions and methods of the appended claims are not limited in scope by the specific compositions and methods described herein, which are intended as illustrations of a few aspects of the claims and any compositions and methods that are functionally equivalent are intended to fall within the scope of the claims. Various modifications of the compositions and methods in addition to those shown and described herein are intended to fall within the scope of the appended claims. Further, while only certain representative compositions and method steps disclosed herein are specifically described, other combinations of the compositions and method steps also are intended to fall within the scope of the appended claims, even if not specifically recited. Thus, a combination of steps, elements, components, or constituents may be explicitly mentioned herein or less, however, other combinations of steps, elements, components, and constituents are included, even though not explicitly stated. The term “comprising” and variations thereof as used herein is used synonymously with the term “including” and variations thereof and are open, non-limiting terms. Although the terms “comprising” and “including” have been used herein to describe various embodiments, the terms “consisting essentially of” and “consisting of” can be used in place of “comprising” and “including” to provide for more specific embodiments of the invention and are also disclosed. Other than in the examples, or where otherwise noted, all numbers expressing quantities of ingredients, reaction conditions, and so forth used in the specification and claims are to be understood at the very least, and not as an attempt to limit the application of the doctrine of equivalents to the scope of the claims, to be construed in light of the number of significant digits and ordinary rounding approaches.

1.-56. (canceled)

57. A coating composition comprising
a copolymer derived from polymerizing monomers comprising a vinyl aromatic monomer present in an amount of at least 40% by weight of the copolymer, butadiene present in an amount of at least 25% by weight of the copolymer, and an acid monomer present in an amount of from 0.9% to 2.7% by weight of the copolymer, in the presence of a tertiary chain transfer agent; wherein the tertiary chain transfer agent is present in an amount of from 1 to 2.2 parts per hundred parts monomers present in the copolymer and reduces the theoretical glass transition temperature (Tg) of the copolymer by at least 5° C. compared to a copolymer polymerized using identical monomers in the absence of the tertiary chain transfer agent;
a filler comprising at least one pigment;
a thickener;
a defoamer; and
water;
wherein the composition when dried, has a tensile strength of greater than 400 psi and an elongation at break of greater than 200% as set forth in ASTM D-2370 at 23° C.

58. The coating composition of claim 57, wherein the coating composition has a thickness of 2 mils or greater.

59. The coating composition of claim 57, wherein the coating composition when dried, has a blush resistance of at least 24 hours when exposed to water.

60. The coating composition of claim 57, wherein the coating composition when dried, has a water absorption of less than 10% by weight at 168 hours, according to a modified DIN 53-495 test.

61. The coating composition of claim 57, wherein the coating composition has a wet peel strength of at least 6 lbf according to a modified ASTM C794-93 test method.

62. The coating composition of claim 57, wherein the coating composition has a dry peel strength of at least 7 lbf according to a modified ASTM C794-93 test method.

63. The coating composition of claim 57, wherein the coating composition has a water permeance of less than 0.1 perm, according to ASTM E-96 A.

64. The coating composition of claim 57, wherein the coating composition has a water permeance of 0.2 or less perm, according to ASTM E-96 B.

65. The coating composition of claim 57, wherein the coating composition is a seam coating.

66. The coating composition of claim 57, wherein the copolymer is derived from 40%-80% by weight, of the vinyl aromatic monomer.

67. The composition of claim 57, wherein the acid monomer is selected from acrylic acid, methacrylic acid, itaconic acid, maleic acid, fumaric acid, crotonic acid, or a mixture thereof.

68. The composition of claim 57, wherein the chain transfer agent is present in an amount to reduce the theoretical glass transition temperature (Tg) of the copolymer by 5° C. to 20° C. compared to a copolymer polymerized using identical monomers in the absence of the chain transfer agent.

69. The composition of claim 57, wherein the chain transfer agent is present in an amount sufficient to reduce the gel content of the copolymer by 5% or greater, compared to a copolymer polymerized using identical monomers in the absence of the chain transfer agent.

70. The composition of claim 57, wherein the chain transfer agent is present in an amount of from 1 part to 4 parts per hundred monomers present in the copolymer.

71. The composition of claim 57, wherein the chain transfer agent is selected from n-octyl mercaptan, n-dodecyl mercaptan, t-octyl mercaptan, tetradecyl mercaptan, hexadecyl mercaptan, B-mercaptoethanol, 3-mercaptopropanol, tert-nonyl mercaptan, tert-dodecyl mercaptan, 6-mercaptomethyl-2-methyl-2-octanol, 4-mercapto-3-methyl-1-butanol, 2-phenyl-1-mercapto-2-ethanol, thioglycolic acid, methyl thioglycolate, n-butyl thioglycolate, i-octyl thioglycolate, dodecyl thioglycolate, octadecyl thioglycolate, methyl-3-mercaptopropionate, butyl-3-mercaptopropionate, i-octyl-3-mercaptopropionate, i-decyl-3-mercaptopropionate, dodecy 1-3-mercaptopropionate, octadecyl-3-mercaptopropionate, or a mixture thereof.

72. The composition of claim 57, wherein the copolymer further comprises an organosilane.

73. The composition of claim 72, wherein the organosilane is represented by the formula (R¹)—(Si)—(OR²)₃, wherein R¹ is a C₁-C₈ substituted or unsubstituted alkyl or a C₁-C₈ substituted or unsubstituted alkene and R², which are the same or different, each is a C₁-C₈ substituted or unsubstituted alkyl group.

74. The composition of claim 57, wherein the copolymer has a theoretical glass-transition temperature of 40° C. or less.

75. The composition of claim 57, wherein the copolymer has a number average particle size of 300 nm or less.
